(19) United States
(12) Patent Application Publication
(10) Pub. No.: US 2025/0370744 A1
(43) Pub. Date: Dec. 4, 2025

(54) LARGE LANGUAGE MODEL (LLM) FOR MODIFYING PULL REQUESTS

(71) Applicant: Salesforce, Inc., San Francisco, CA (US)

(72) Inventor: Anup Ghatage, San Francisco, CA (US)

(21) Appl. No.: 18/731,108

(22) Filed: May 31, 2024

(51) Int. Cl. G06F 8/71; G06F 40/169

(52) U.S. Cl. CPC G06F 8/71; G06F 40/169

(57) ABSTRACT

Methods, systems, apparatuses, devices, and computer program products are described. A processing device may support a large language model (LLM) for automatically improving pull requests to a codebase. To use the LLM, the processing device may create and maintain a vector space tracking information relating to historical pull requests to the codebase. The processing device may receive a new pull request indicating a change to code in the codebase and may determine, from the vector space, a vector corresponding to a code chunk affected by the pull request. The processing device may send, as an input to the LLM, a prompt including the code chunk affected by the pull request and one or more comments from a set of historical comments relating to the code chunk and indicated by the determined vector. The processing device may modify the pull request based on the one or more comments.

### FIELD OF TECHNOLOGY

The present disclosure relates generally to database systems and data processing, and more specifically to large language models (LLMs) for modifying pull requests.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some systems (e.g., CRM systems), users may define code-based solutions to handle CRM operations, data operations, or other functions. For example, a system may support a codebase for an organization including one or more software applications, components, or other code defining operations for the organization. A user may update code in the codebase, for example, using a pull request that indicates one or more changes to the codebase. However, in some cases, the one or more changes may introduce inefficiencies or errors into the code of the codebase. Failing to identify and mitigate such inefficiencies or errors in the pull request prior to merging the changes with the codebase may result in inefficient usage of processing resources, inefficient usage of memory resources, security concerns, broken code, or other potential issues relating to the code of the codebase.

### BRIEF DESCRIPTION OF THE DRAWINGS

FIG. 1 illustrates an example of a system for cloud computing that supports a large language model (LLM) for modifying pull requests in accordance with aspects of the present disclosure.

FIGS. 2 and 3 show examples of systems that support LLMs for modifying pull requests in accordance with aspects of the present disclosure.

FIG. 4 shows an example of a prompt generation procedure that supports an LLM for modifying pull requests in accordance with aspects of the present disclosure.

FIG. 5 shows an example of a process flow that supports an LLM for modifying pull requests in accordance with aspects of the present disclosure.

FIG. 6 shows a block diagram of an apparatus that supports an LLM for modifying pull requests in accordance with aspects of the present disclosure.

FIG. 7 shows a block diagram of a pull request manager that supports an LLM for modifying pull requests in accordance with aspects of the present disclosure.

FIG. 8 shows a diagram of a system including a device that supports an LLM for modifying pull requests in accordance with aspects of the present disclosure.

FIGS. 9 through 11 show flowcharts illustrating methods that support LLMs for modifying pull requests in accordance with aspects of the present disclosure.

### DETAILED DESCRIPTION

Efficient and accurate review of work products can pose challenges across many domains. For example, software engineers or other programmers may draft new software applications or code updates for a codebase. Users may review changes to the codebase to ensure the code works properly, efficiently manages available resources, and follows security protocols and other coding best practices. For example, a code update could potentially introduce significant processing overhead or memory overhead if the code update is not programmed to operate efficiently. Additionally, or alternatively, the code update could introduce security concerns, allowing access to sensitive data or calling external functions that have not been reviewed or approved. Accurate code review may provide users tools to review such code updates and suggest improvements to mitigate potential issues. However, code review may be susceptible to human error or biases. Additionally, or alternatively, users may fail to leverage previous suggestions or code updates, reducing the efficiency of the code review process. Other forms of document review may suffer from similar problems.

As described herein, a system may implement techniques to perform automated reviews using a large language model (LLM). In some cases, the system may review code changes defined by pull requests using the LLM. To effectively use the LLM, the system may create and maintain a vector space tracking information relating to historical pull requests for a codebase. The vectors of the vector space may indicate previous comments, previous code updates, or both relating to specific lines or sections of code in the codebase. The system may receive a new pull request indicating a change to a portion of code in the codebase and may identify, from the vector space, a vector corresponding to a code chunk affected by the pull request. The system may send, as an input to the LLM, a prompt including the code chunk affected by the pull request and one or more comments from a set of historical comments relating to the code chunk and indicated by the identified vector. In this way, the system may generate the prompt to provide additional historical context for improved review accuracy and domain-specific context. The LLM may output an indication of one or more comments for the pull request, one or more updates to the pull request, or both. The system may modify the pull request based on the LLM output. For example, the system may add the one or more comments to the pull request, modify a code change indicated by the pull request based on the LLM output, or both. The comments, modifications to the code change, or both may mitigate inefficiencies (e.g., in memory resources, in processor resources) introduced by the code change, fix security concerns introduced by the code change, fix errors in the code, or any combination thereof. In some cases, the LLM may provide a first layer of code review.

The LLM may be trained at a specific time. However, the codebase for an organization may update after this time, causing the LLM to fall out-of-date with recent trends, comments, or coding practices associated with the codebase. Rather than retraining or fine-tuning the LLM, which may involve a significant processing overhead, the system may update the vector space to remain in-tune with the latest codebase updates. By synchronizing the vector space with the codebase updates and leveraging retrieval-augmented generation (RAG) for the LLM prompts using the vector space, the system may account for changes to the codebase while efficiently managing processing resources (e.g., refraining from updating the LLM itself). Additionally, or alternatively, the system may quantize the LLM to reduce a compute power (e.g., memory overhead) associated with running the LLM. Such improvements may reduce the processing overhead, memory overhead, or both associated with performing automated code review using the LLM.

Aspects of the disclosure are initially described in the context of an environment supporting an on-demand database service. Additional aspects of the disclosure are described with reference to systems and processes for creating a vector space, generating a prompt, and using an LLM to modify a pull request. Aspects of the disclosure are further illustrated by and described with reference to apparatus diagrams, system diagrams, and flowcharts that relate to LLMs for modifying pull requests.

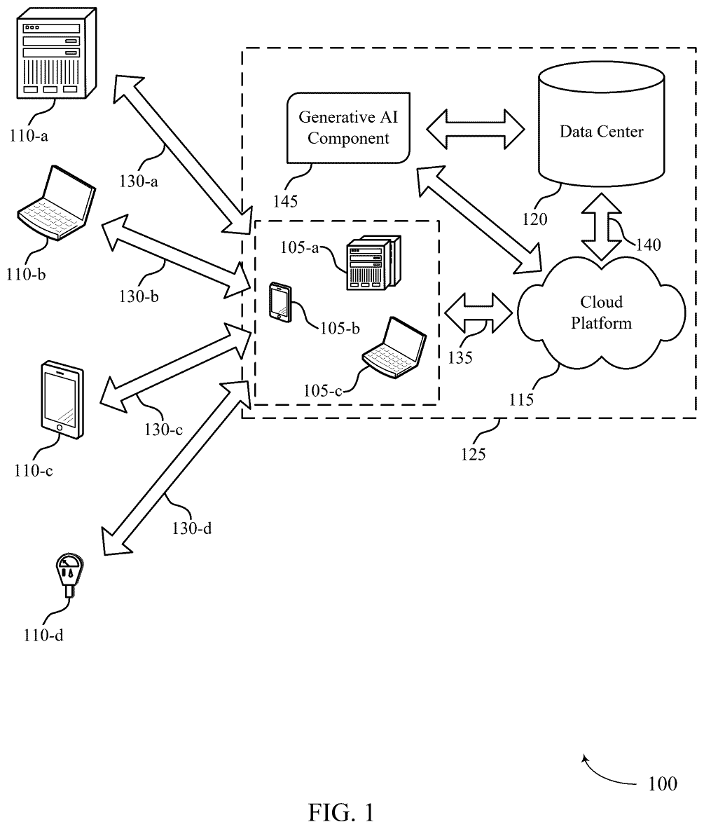

FIG. 1 illustrates an example of a system 100 for cloud computing that supports an LLM for modifying pull requests in accordance with aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including-but not limited to-client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135 and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

The system 100 may support automated code review for pull requests. To support such techniques, the system 100 may include a generative artificial intelligence (AI) component 145. The generative AI component 145 may be an example or a component of an LLM, such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

The generative AI component 145 may be an example of an LLM for modifying pull requests. The LLM (e.g., an open-source LLM) may be trained or pre-trained on open datasets (e.g., random or otherwise generic corpuses of data) in an initial training phase. The initial training may tune the weights of the LLM based on the open datasets, where the weights may represent the stored “knowledge” of the LLM. The system 100 may further train, or finetune, the LLM with custom data to improve the domain-specific knowledge of the LLM. For example, the system 100 may tune one or more relevant weights of the LLM using data relating to code review to improve the LLM's “knowledge” of code review beyond the initial, non-specific training. In some examples, the system 100 may tune the LLM using historical code review comments. The system 100 may train the LLM to process code (e.g., code updates indicated by pull requests) and generate one or more comments based on the code. Accordingly, the LLM may be a customized LLM finetuned using historical code reviews by engineers.

The system 100 may train and run the LLM locally to reduce costs, improve security, or both. The LLM may be any applicable language model that supports code review. For example, the LLM may be Mistral-7b v0.1, Mistral-7b v0.2, OpenHermes-7b, or any other language model.

Some other systems may have humans (e.g., other users) perform code review. For example, a team of users may perform a significant quantity of code commits (e.g., code updates) each day. Prior to merging a code update with a codebase, the team may perform the code review. These other systems may include manual code review by other engineers based on the engineers' historical knowledge of the codebase. However, humans may be susceptible to human error and biases in code review. Additionally, in some cases, humans may fail to account for inefficiencies in the code. For example, the humans may check for errors in the code, but may fail to evaluate whether the code efficiently performs the relevant functions. Additionally, or alternatively, humans may fail to automatically ensure that the code maintains security protocols. Furthermore, different humans may review code for different features or issues, resulting in inconsistencies across code review procedures.

To improve the code review process, the system 100 may use the LLM (e.g., generative AI component 145) to automate code review (e.g., a first pass of the code review process). The LLM may review (e.g., process) incoming code review requests and post comments to changed code chunks, modify the code changes, or both. The LLM may provide a more robust and accurate code review than static analysis tools. By automating the code review (or a portion of the code review), the system 100 may reduce the overall end-to-end time spent reviewing code prior to committing code changes to the codebase. Reducing the time for code review may reduce the latency involved in merging code updates with the codebase, increasing productivity and efficiency in the system 100.

Other systems may use LLMs to handle tasks. However, off-the-shelf LLMs may suffer from one or more potential drawbacks. For example, an LLM is trained on a corpus of data at a specific time. The LLM may fail to account for any information that becomes available after this specific time, such that the LLM has a cut-off date for knowledge (e.g., based on the pre-training data for the LLM, the finetuning of the LLM, or both). Accordingly, the LLM may fail to remain up-to-date on the latest code review best practices and code review comments. Training or finetuning the LLM to account for the latest code review information may be compute and time intensive processes, such that updating the LLM daily or even weekly may not be feasible (or may be inefficient and expensive). Additionally, or alternatively, running an LLM may involve a significant memory overhead. For example, the memory resources for running some LLMs may not be supported by a central processing unit (CPU). Instead, a graphics processing unit (GPU) may provide the memory resources to run such LLMs. However, the GPU may fail to support the same security features as a CPU. Additionally, the significant memory and processing resource overhead associated with running the LLM may introduce inefficiencies into these other systems.

In contrast, the system 100 may implement techniques to improve the efficiency of the LLM for code review. For example, the system 100 may use RAG techniques to modify prompts with up-to-date data relating to the latest code review best practices and code review comments. Accordingly, the system 100 may efficiently modify the prompts, rather than the LLM, to account for updates in code review. Modifying a prompt may involve a significantly lower processing overhead and memory overhead than retraining or finetuning an LLM. Additionally, or alternatively, the system 100 may quantize the LLM to reduce the memory overhead associated with running the LLM. For example, the system 100 may convert the weights of the LLM from floating point values to relatively lower precision values (e.g., relatively lower prevision floating point or integer values). In some cases, the system 100 may reduce the weights of the LLM from 32 bit integer values to 16, 8, or 4 bit integer values. Reducing the precision of the LLM weights may reduce the compute power involved in computations using the LLM. Accordingly, quantizing the LLM may allow the LLM to run on CPUs (e.g., instead of GPUs). The quantization may tradeoff a relatively small amount of accuracy for relatively large improvements in processing time and overhead. Additionally, running the LLM on a CPU instead of a GPU may significantly reduce compute costs associated with performing the LLM-based code review. In some examples, the system 100 may additionally host the LLM locally (e.g., internal to the system 100, within a private domain). Hosting the LLM locally may improve security and allow the system 100 to control data access and responses from the LLM. The system 100 may additionally air-gap the LLM for further security improvements.

The system 100 may support ranking code review comments for RAG to inject prompts with relevant historical information. For example, the system 100 may filter and create a finetuning dataset of mappings between review comments and relevant code chunks. The system 100 may embed, rank, and store previous code review comments (e.g., historical comments) to code chunk mappings. The system 100 may look up the stored mappings based on a ranking of the comments and may select a set of relevant comments to include with a prompt to the LLM.

In some examples, the system 100 may use similar techniques, a similar LLM, or both to review other works. For example, the system 100 may support automated review of other types of documents beyond code updates.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

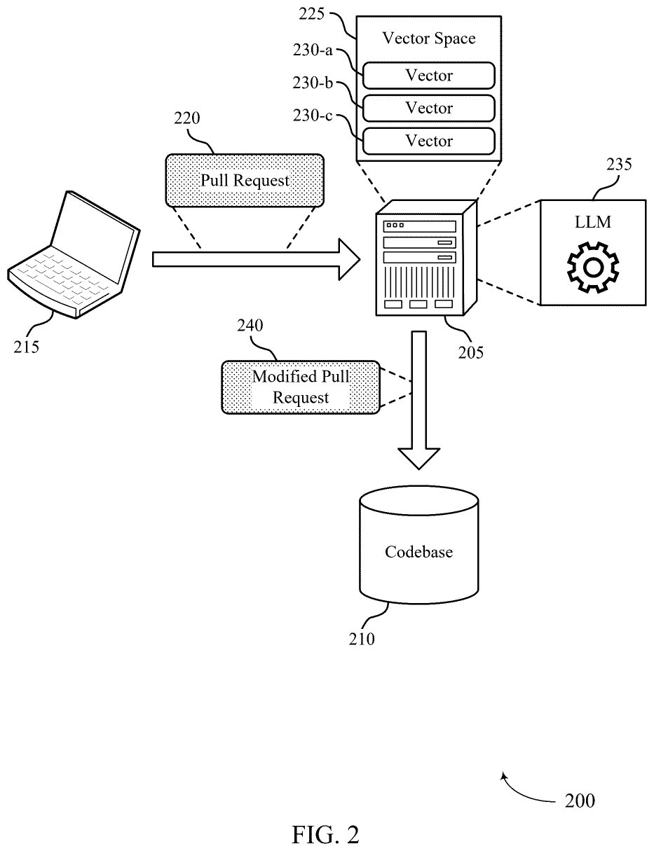

FIG. 2 shows an example of a system 200 that supports an LLM for modifying pull requests in accordance with aspects of the present disclosure. The system 200 may include a processing device 205, a codebase 210, and a user device 215. The processing device 205 may be a component of a system 100, the codebase 210 may be a component of a data center 120 or a cloud platform 115, and the user device 215 may be an example of a cloud client 105 or a contact 110, as described with reference to FIG. 1. The processing device 205 may be an example of any processing device or system, such as an application server, a database server, a cloud-based server or service, a worker server, a server cluster, a virtual machine, a container, a network device, a user device, or any combination of these or other computing devices. In some examples, the processing device 205 may be an example or a component of the user device 215 or the codebase 210. The user device 215 may be an example of a smartphone, a laptop, a desktop, a smartwatch, or any other device that supports inputs and outputs for a user operating the device. The codebase 210 may be an example of any data storage system storing code for a software program, a component, an application system, an organization, or any combination thereof. The system 200 may support automatically generating comments and modifying a pull request 220 to improve programming procedures.

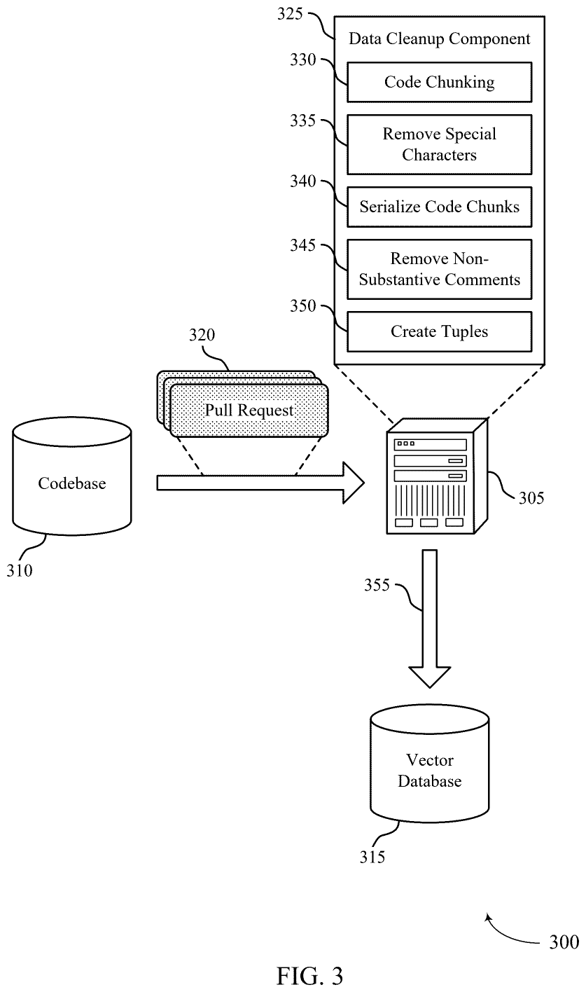

The processing device 205 or another device, such as a vector database, may support a vector space 225. For example, the processing device 205 may create or otherwise define the vector space 225 using historical pull requests, as described herein with reference to FIG. 3. The vector space 225 may include a set of vectors corresponding to different portions of code in the codebase 210. For example, the vector space 225 may include a first vector 230-a corresponding to a first portion of code, a second vector 230-b corresponding to a second portion of code, and a third vector 230-c corresponding to a third portion of code. The processing device 205 may support retrieval-augmented generation (RAG) techniques to improve LLM functionality. For example, the processing device 205 may use the vector space 225 to decorate a prompt for an LLM 235 with additional relevant information.

A user may define a pull request 220 using the user device 215. The pull request 220 may indicate a proposed change to code at the codebase 210. The pull request 220 may be an example of a GitHub pull request or some other code update. The processing device 205 may receive the pull request 220 from the user device 215 for code review.

The processing device 205 may search the vector space 225 for information relevant to the pull request 220. For example, the processing device 205 or another data storage device (e.g., a vector database) may format and store previous code review comments and code snippets in a manner that supports efficient search and retrieval of the comments. The processing device 205 may decorate a prompt to an LLM 235 using the retrieved relevant comments. The processing device 205 may update the vector space 225 to account for updates to the codebase 210. For example, code changes over time, so the vectors are updated to track one or more facets of the codebase 210. Using the up-to-date vector space 225, the processing device 205 may identify a previous comment on a function that may be relevant to a new code change within that function.

The vectors embedded in the vector space 225 may correspond to specific file names, function names, or both within the codebase 210. The processing device 205 receiving the pull request 220 may iterate over a list of code chunks with changes defined in the pull request 220 to extract the modified file name, the modified function name, the changed line numbers (e.g., a starting line number for a proposed code change, an ending line number for the proposed code change), or some combination thereof. With this information, the processing device 205 may rank the vector embeddings of the vector space 225 for relevancy. For example, the processing device 205 may search for a first set of vectors with a matching file name, a second set of vectors from the first set with a matching function name, and a third set of vectors from the first set with historical code review comments that apply to the changed line numbers. Additionally, or alternatively, the processing device 205 may perform any other vector lookup techniques, such as Euclidean distance, cosine similarity, inner product, or any other vector search functions. If the processing device 205 fails to identify a matching file name, a matching function name, or any comments within the changed line numbers for a code chunk, the processing device 205 may skip the code review process for the code chunk. Otherwise, the processing device 205 may identify one or more comments relevant to a code chunk.

The processing device 205 may generate a prompt for the LLM 235 based on the one or more comments and the code chunk changed by the pull request 220. For example, the processing device 205 may rank the comments based on relevancy (e.g., using any set of ranking metrics). The processing device 205 may decorate the prompt with a subset of the comments (e.g., a threshold quantity, such as the two most relevant comments). Limiting the quantity of comments to include in the prompt may improve the relevancy of the comments while avoiding polluting the actual prompt (e.g., with irrelevant or excessive information). Additionally, or alternatively, the processing device 205 may limit the quantity of comments to include in the prompt to support a context window size for the LLM 235 (e.g., to fit within the context window). Decorating the prompt with recent relevant comments may support a recency bias for reviewing the code chunk, allowing the LLM 235 to account for up-to-date code review practices. The processing device 205 may additionally decorate the prompt with the code chunk corresponding to the comments. For example, the prompt may state:
Here is a code snippet: {code chunk}
Here are some previous comments based on this code snippet: {comments}
Please review the code snippet based on your knowledge and use relevant comments provided to draw insights on the changes.

The processing device 205 may send the prompt for processing by the LLM 235 (e.g., as an input to the LLM's context window). The LLM 235 may execute the prompt and output a set of comments to write back to the pull request 220 (e.g., to write to the corresponding code chunk). Additionally, or alternatively, the LLM 235 may output modifications to the pull request 220, such as changes to the code or the code updates. The processing device 205 may modify the pull request 220 based on the LLM output and may send the modified pull request 240 to the codebase 210 (e.g., for further review, for merging with the codebase 210).

Using the techniques described herein, the system 200 may generate a first pass code review based on distilled real engineer reviews (e.g., historical reviews) on relevant lines of code. This first pass may reduce the burden on a final human reviewer, reduce the cycle time for the code review, improve the accuracy of the code review, or any combination thereof.

Although described herein with reference to code review, the system 200 may support similar techniques for other forms of review. For example, the system 200 may use similar techniques to create redlines, comments, or markups for other documents, such as word documents, portable document format (PDF) documents, presentations, slide decks, emails, or any other documents.

Similar to code, other living documents (e.g., documents with frequent updates made by one or more users) may experience relatively frequency changes to the document contents. Documents may additionally include logical structures, such as paragraphs, numbered sections, headers, pages, slides, or other organizational features that support creating text chunks (e.g., similar to code chunks) that may be changed within the documents. The system 200 may store, in a vector space 225, vector embeddings of text chunks paired with respective lists of tuples for the text chunks (e.g., paragraphs). In such cases, a tuple may include historical comments made on the text chunk (e.g., the paragraph), the line of text on which the comment was made, an indication of a line number for the line of text (e.g., where the line number may be relative to the paragraph), or any combination thereof. Accordingly, the system 200 may create a vector space 225 tracking historical comments to documents for an organization, a specific user, or some other granularity of historical data tracking.

If the system 200 receives a document for review, the system may perform RAG for the document by iterating over a list of text chunks with changes in the document. The system 200 may extract, for the document, a file name, one or more modified paragraph numbers, one or more modified line numbers (e.g., starting line numbers and ending line numbers for the changes), or any combination thereof. The system 200 may use this information to perform a vector search on the vector database. The system 200 may rank the relevant vectors based on matching file name, matching paragraph number (or matching paragraph based on semantically relevant paragraphs or most similar paragraphs), and tuples with line numbers within the changed line numbers. If the system 200 fails to identify any matching file and paragraph with at least one tuple corresponding to the changed line, the system 200 may skip the review for this text chunk (e.g., paragraph).

The system 200 may modify a prompt for an LLM 235 using the identified comments and the indicated changes to the document. For example, the prompt may indicate a changed paragraph and one or more historical review comments relevant to that paragraph. The prompt may request the LLM 235 to review the paragraph based on historical knowledge and use the relevant comments to provide insights on the changes. The LLM 235 may process the prompt and output one or more comments for the modified document, one or more changes to the modified document, or both. The system 200 (e.g., the processing device 205 performing the document review) may automatically modify the document based on the LLM output. According, the system 200 may support other forms of review in addition, or alternative, to code review.

FIG. 3 shows an example of a system 300 that supports an LLM for modifying pull requests in accordance with aspects of the present disclosure. The system 300 may include a processing device 305, a codebase 310, and a vector database 315. The processing device 305 may be an example of a processing device 205 and the codebase 310 may be an example of a codebase 210, as described with reference to FIG. 2. The processing device 305 may be an example of any processing device or system, such as an application server, a database server, a cloud-based server or service, a worker server, a server cluster, a virtual machine, a container, a network device, a user device, or any combination of these or other computing devices. The codebase 310 may be an example of any data storage system storing code for a software program, a component, an application system, an organization, or any combination thereof. The vector database 315 may be an example of any data storage system storing vector definitions for a vector space. In some examples, the vector database 315 may be a component of the processing device 305. For example, the processing device 305 may host a vector space. The system 300 may support creating the vector space based on historical pull requests 320 for the codebase 310.

The processing device 305 may filter and store code chunks to support searching the code chunks for relevant comments via a vector space. The processing device 305 may retrieve a set of historical pull requests 320 from the codebase 310. For example, the codebase 310 may store previously-merged pull requests. The processing device 305 may retrieve all historical pull requests 320, a subset of historical pull requests 320 corresponding to a time frame for vectorization, or batches of historical pull requests 320 (e.g., based on available resources for processing and vectorizing the pull requests). In some examples, the processing device 305 may get or list the historical pull requests 320 using an application programming interface (API). In some cases, the retrieved historical pull requests 320 may correspond to a single organization or a single tenant of a multi-tenant database system. For example, the processing device 305 may retrieve organization-specific pull requests from the codebase 310 to create an organization-specific vector space supporting code review for that organization.

An example historical pull request may include a list of code chunks and comments attached to the code chunks. A code chunk may define a new version of code. For example, the code chunk may indicate one or more changes to a specific file, a specific function, or both stored in the codebase 310. The pull request, the code chunks, the comments, or some combination thereof may be in a JavaScript object notation (JSON) format.

The processing device 305 may receive a historical pull request of the set of historical pull requests 320 and may parse the historical pull request (e.g., parse the JSON script) to convert the pull request into one or more code chunk-comment pairs. In some examples, the processing device 305 may include a data cleanup component 325 to process the pull requests for vector embedding. The data cleanup component 325 may perform code chunking 330 to determine the code chunks indicated by the pull requests. A code chunk may be defined by the codebase 310 or determined by the processing device 305. In some examples, a code chunk may be defined relative to a comment. For example, the comment may correspond to a code chunk spanning a threshold quantity of lines (e.g., 10 lines of code before the comment and 10 lines of code after the comment). In some other examples, the code chunk may be a function or other component defined in the code.

In some cases, the processing device 305 may perform “smart” chunking to determine the code chunks. For example, the processing device 305 may determine the code chunks based on one or more new lines (e.g., new line characters), one or more delimiters, one or more brackets, one or more functions, one or more special characters, or any combination thereof in the historical pull requests 320 or in the code of the codebase 310. The smart chunking procedure may identify logical beginnings and endings for the code chunks based on the content of the code.

The processing device 305 may clean up the code chunks by removing special characters 335 and serializing the code chunks 340. For example, the processing device 305 may escape (e.g., delete, remove, replace) special characters, trigraphs, or any other text representing different operations. By escaping such text in the code chunks, the data cleanup component 325 may improve the ability of an LLM to consume and accurately process the code chunks (e.g., as training data, as portions of a prompt). The processing device 305 may reformat the resulting code chunks into single lines of text for processing by the LLM.

The processing device 305 may additionally, or alternatively, clean up the comments corresponding to the code chunks. For example, the processing device 305 may remove non-substantive comments 345. In some examples, non-substantive comments may include reply comments, comments satisfying a comment length threshold (e.g., shorter than a threshold length, longer than a threshold length), standard comments, or any combination thereof. Cleaning up the non-substantive comments may remove comments such as “OK,” “Fixed,” “Thank you,” “Updated accordingly,” and other comments that fail to substantively comment on the content of the code chunks.

The processing device 305 may create tuples 350 using the code chunks and comments (e.g., following the cleanup of the code chunks, the comments, or both) to support efficient searching of the code chunks for relevant comments. The processing device 305 may embed vectors in a vector space based on the tuples. In some cases, the processing device 305 may host the vector space. In some other cases, a vector database 315 may host the vector space. The processing device 305, the vector database 315, or both may host separate vector spaces for different organizations or tenants (e.g., to support secure vector searches on organization or tenant-specific data). Such separation of vector spaces may improve the security of tenant data handled by the system 300.

A tuple may include a code chunk (e.g., a serialized code chunk) and a corresponding review comment from the set of historical pull requests 320. For example, the tuple may include a historical review comment, a line of code on which the review comment was made, an indication of a line number for the line of code, or some combination thereof. The processing device 305, the vector database 315, or both may store code portions (e.g., functions) and respective lists of tuples for the code portions. The processing device 305 may embed the function, such that the vector space indicates a function embedding and the corresponding list of tuples for the function. The vector embedding 355 may define the vector space and may improve vector searches for relevant comments for pull requests.

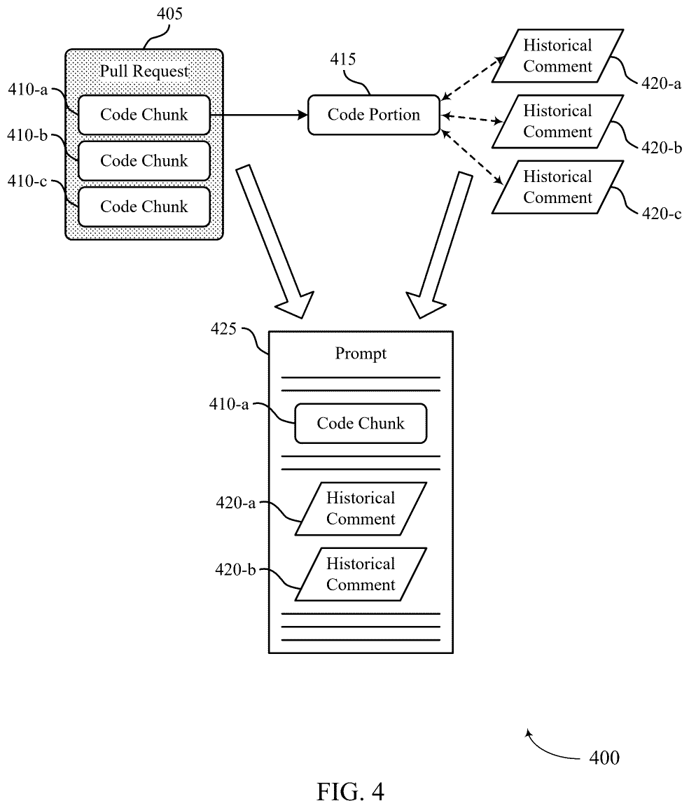

FIG. 4 shows an example of a prompt generation procedure 400 that supports an LLM for modifying pull requests in accordance with aspects of the present disclosure. In some examples, a processing device, such as a processing device 205 or a processing device 305 as described with reference to FIGS. 2 and 3, may perform the prompt generation procedure 400. The processing device may perform the prompt generation procedure 400 to create—or otherwise determine—a prompt 425 for an LLM, such as an LLM 235 as described with reference to FIG. 2.

The prompt generation procedure 400 may populate a prompt 425 with pull request-specific information and historical information (e.g., to support RAG). In some cases, the processing device may create multiple prompts 425 for a pull request 405. For example, the processing device may generate a prompt 425 for each code chunk with a proposed change defined in the pull request 405. As an example, a user may create a pull request 405 that changes code within a first code chunk 410-a, a second code chunk 410-b, and a third code chunk 410-c. The processing device may create a prompt 425 for each of the code chunks affected by the pull request 405 and may use the prompts to perform separate reviews of the code chunks using the LLM.

The processing device may identify a code portion 415 corresponding to a code chunk 410-a. For example, the processing device may determine the code portion 415 based on a vector search of a vector space. The processing device may identify a set of historical comments associated with the code portion 415. For example, the historical comments may be comments made during previous reviews of the code portion 415 (e.g., a function defined in the code, a code file).

In some examples, the processing device may rank the historical comments corresponding to the code portion 415 for relevance. For example, the processing device may rank the historical comments (e.g., comments made on a specific function) based on one or more factors. In some examples, the historical comments may be ranked based on timestamps for the historical comments (e.g., prioritizing recent comments relatively more than older comments), lengths of the historical comments (e.g., prioritizing comments satisfying a threshold length), line numbers of the historical comments (e.g., prioritizing comments made relatively nearer to the beginning of a function definition), semantic relationships between the historical comments and the corresponding code function (e.g., prioritizing comments with language relating to the function name), or any combination thereof.

The processing device may populate the prompt 425 using a subset of historical comments in accordance with the ranking. For example, the processing device may rank the historical comments to include a first historical comment 420-a ranked first (or relatively most relevant), a second historical comment 420-b, ranked second, and a third historical comment 420-c ranked third (or relatively least relevant). The processing device may insert a threshold quantity of historical comments (e.g., up to two comments) into the prompt 425. The processing device may insert the first historical comment 420-a and the second historical comment 420-b into the prompt 425 based on the ranking and may refrain from inserting the third historical comment 420-c. Additionally, the processing device may populate the prompt 425 with the relevant code chunk 410-a. For example, the code chunk 410-a may indicate the change proposed by the pull request 405 for the code chunk 410-a. The prompt 425 may request that the LLM reviews the code chunk 410-a based on the previous comments (e.g., the first historical comment 420-a and the second historical comment 420-b) relating to the code portion 415.

An example prompt 425 may be defined as:

prompt = ″″″
### System Prompt
You are a C and Java programming expert. You are designed to review code and provide
helpful comments.
### User input
I will explain the format of the github patch and then provide you with a patch to review.
The github patch is of the following format:
lines added have ‘+’ as the first character of line.
line with “@ −14,6 +14,12 @@” line entries means changes start from line 14 of file, 6 lines
removed and 12 added ‘ ‘ ‘
file = { file_name}
{patch}
‘ ‘ ‘
Read the patch carefully and provide comments if any, specifically for lines you think
deserve to be changed.
Provide your comments in the following JSON format:
{ {
filename : <file for the patch being reviewed>
line_no : <line number for which review comment is being made>
review_comment: <actual text of review comment for given line_not>
} }
Here are some previous comments based on this code:
{comments}
Do not write anything before or after the expected formatted output.
Do not write any python code.
Your response below will be the JSON as described and nothing else.
### Response

In the above example prompt 425, the {patch} may include the code chunk 410-a and the {comments} may include the historical comment 420-a and the historical comment 420-b. While the above is one example, the system may support other prompts or prompt formats. The prompt 425 may be used as a generative prompt input to an LLM for automated code review using any of the techniques described herein.

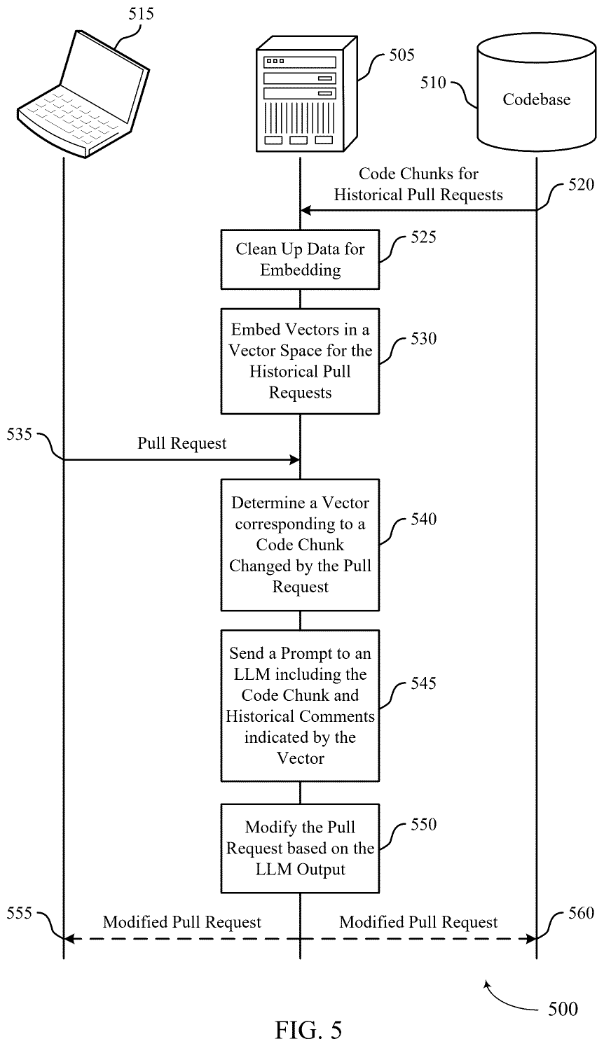

FIG. 5 shows an example of a process flow 500 that supports an LLM for modifying pull requests in accordance with aspects of the present disclosure. The process flow 500 may be implemented by a system including one or more processing devices 505, one or more codebases 510, one or more user devices 515, or any combination thereof. The system may support pull request modifications based on an LLM output. A processing device 505 may be an example of a computing device, an application server, a database server, a cloud-based server or service, a worker server, a server cluster, a virtual machine, a container, a network device, a user device, or any combination of these or other computing devices or systems. The codebase 510 may store code and code updates for one or more tenants of a multi-tenant database system. The user device 515 may be an example of a laptop, desktop computer, mobile device, smartphone, smartwatch, tablet, virtual reality (VR) device, or any other smart device. The user device 515 may include a UI that can present information (e.g., visually, audibly) corresponding to pull requests to the codebase 510, as described herein with reference to FIGS. 1 through 4. Alternative examples of the following may be implemented, where some processes are performed in a different order than described or are not performed at all. In some examples, processes may include additional features not mentioned below, or further processes may be added. Additionally, or alternatively, one or more operations described herein as performed by the processing device 505 may instead be performed by the user device 515 (e.g., locally) or the codebase 510.

At 520, the processing device 505 may retrieve data from the codebase 510 to create a vector space. For example, the processing device 505 may retrieve, from the codebase 510, a set of multiple code chunks and a set of multiple historical comments associated with historical pull requests to the codebase.

At 525, the processing device 505 may clean up the retrieved code chunks, the retrieved historical comments, or a combination thereof for vector embedding. In some examples, the processing device 505 may remove special characters from the retrieved set of multiple code chunks, serialize respective code chunks of the retrieved set of multiple code chunks into single lines of text, or both. Additionally, or alternatively, the processing device 505 may remove, from the retrieved set of multiple historical comments, a subset of non-substantive comments. For example, the processing device 505 may remove a first subset of comments corresponding to reply comments (e.g., comments added in response to other comments), a second subset of comments satisfying a comment length threshold (e.g., comments shorter than ten characters), a third subset of comments corresponding to a list of standard comments (e.g., “Thank you,” “Updated Accordingly,” “Test”), or any combination thereof. The processing device 505 may generate tuples based on the retrieved code chunks and the retrieved historical comments. For example, a tuple may indicate a respective function and a respective list including one or more historical comments and one or more line numbers corresponding to the one or more historical comments.

At 530, the processing device 505 may embed the tuples as vectors in a vector space (e.g., hosted at the processing device 505, hosted at a different device or data store, such as a vector database). Each vector may correspond to a respective portion of code, such as a respective function defined in the codebase 510. A vector may indicate one or more historical comments associated with one or more code chunks for the corresponding portion of code (e.g., the corresponding function). The vector space may support a vector search using any vector search algorithm or technique.

At 535, the processing device 505 may receive a new pull request (e.g., prior to merging the pull request with the codebase 510). For example, a user operating the user device 515 may define the pull request. The pull request may indicate a change to a code chunk of the codebase 510. In some cases, the pull request may indicate multiple changes to the code chunk or may indicate one or more changes to multiple code chunks of the codebase 510. The user device 515 may send the pull request to the processing device 505 for review (e.g., for an initial review).

At 540, the processing device 505 may determine, from the vector space, a vector corresponding to a portion of code including the code chunk affected by the pull request. For example, the pull request may update a method defined for a function of the code, and the processing device 505 may identify the vector of the vector space corresponding to the function. The vector may indicate a set of historical comments relating to the function. For example, the vector may correspond to a tuple stored for the historical pull requests, where the tuple indicates the function and the set of historical comments relating to the function.

At 545, the processing device 505 may send a prompt as an input to an LLM to review the pull request. The processing device 505 may generate the prompt to include the code chunk affected by the pull request (e.g., including the change to the code chunk indicated by the pull request) and at least a subset of the set of historical comments indicated by the determined vector. In some examples, the processing device 505 may populate the prompt with a subset of the historical comments further based on a threshold quantity of historical comments. For example, the processing device 505 may select the X most relevant historical comments to include in the prompt based on a relevancy ranking of the comments. The relevancy ranking may be based on timestamps for the historical comments, lengths of the historical comments, line numbers of the historical comments, semantic relationships between the historical comments and the corresponding functions in the code, or any combination thereof. In some examples, the threshold quantity of historical comments to include in the prompt, X, may be based on a context window size of the LLM, where X may be static or dynamic. For example, the processing device 505 may select different quantities of historical comments to include in prompts based on the lengths of the comments, the lengths of the prompts without the added comments, and the context window size supported by the LLM.

In response to the prompt, the LLM may output one or more comments for the pull request, one or more changes to the pull request, or both. The one or more comments may be copies of historical comments or may be new comments based on the LLM. At 550, the processing device 505 may modify the pull request to include the one or more comments, to update the code change indicated by the pull request, or both based on the output of the LLM.

In some examples, at 555, the processing device 505 may send the modified pull request to the user device 515 for display via a UI. A user operating the user device 515 may view the modified pull request and may further update the pull request based on the one or more comments, may perform a further review of the pull request, or both. After the user review, the user may select to merge the modified pull request with the codebase 510. In some other examples, at 560, the processing device 505 may send the modified pull request to the codebase 510 (e.g., for further review or to automatically merge with the codebase 510 based on the LLM-based review).

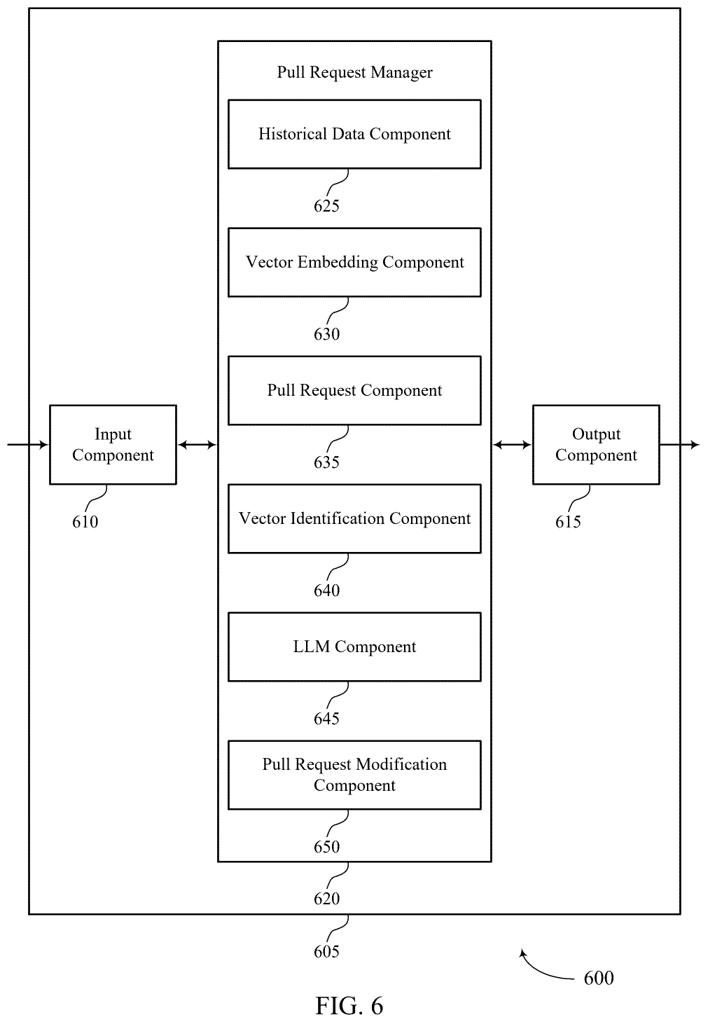

FIG. 6 shows a block diagram 600 of a device 605 that supports an LLM for modifying pull requests in accordance with aspects of the present disclosure. The device 605 may include an input component 610, an output component 615, and a pull request manager 620. The device 605, or one or more components of the device 605 (e.g., the input component 610, the output component 615, the pull request manager 620), may include at least one processor, which may be coupled with at least one memory, to support the described techniques. Each of these components may be in communication with one another (e.g., via one or more buses).

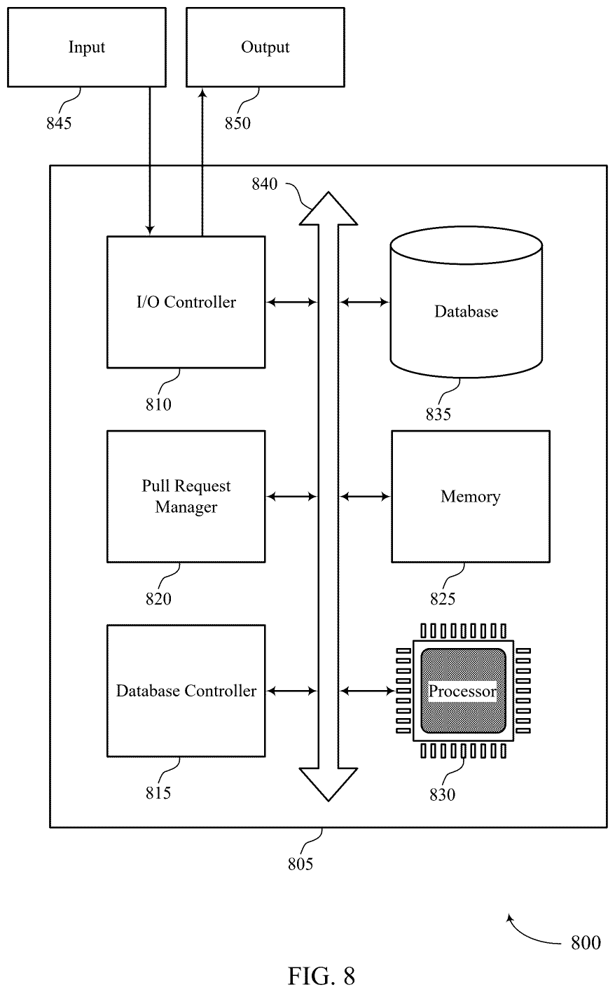

The input component 610 may manage input signals for the device 605. For example, the input component 610 may identify input signals based on an interaction with a modem, a keyboard, a mouse, a touchscreen, or a similar device. These input signals may be associated with user input or processing at other components or devices. In some cases, the input component 610 may utilize an operating system such as iOS®, ANDROID®, MS-DOS®, MS-WINDOWS®, OS/2®, UNIX®, LINUX®, or another known operating system to handle input signals. The input component 610 may send aspects of these input signals to other components of the device 605 for processing. For example, the input component 610 may transmit input signals to the pull request manager 620 to support an LLM for modifying pull requests. In some cases, the input component 610 may be a component of an input/output (I/O) controller 810 as described with reference to FIG. 8.

The output component 615 may manage output signals for the device 605. For example, the output component 615 may receive signals from other components of the device 605, such as the pull request manager 620, and may transmit these signals to other components or devices. In some examples, the output component 615 may transmit output signals for display via a UI, for storage in a database or data store, for further processing at a server or server cluster, or for any other processes at any number of devices or systems. In some cases, the output component 615 may be a component of an I/O controller 810 as described with reference to FIG. 8.

For example, the pull request manager 620 may include a historical data component 625, a vector embedding component 630, a pull request component 635, a vector identification component 640, an LLM component 645, a pull request modification component 650, or any combination thereof. In some examples, the pull request manager 620, or various components thereof, may be configured to perform various operations (e.g., receiving, monitoring, transmitting) using or otherwise in cooperation with the input component 610, the output component 615, or both. For example, the pull request manager 620 may receive information from the input component 610, send information to the output component 615, or be integrated in combination with the input component 610, the output component 615, or both to receive information, transmit information, or perform various other operations as described herein.

The pull request manager 620 may support automatically modifying pull requests in accordance with examples as disclosed herein. The historical data component 625 may be configured to support retrieving, from a codebase, a set of multiple code chunks associated with historical pull requests to the codebase. The vector embedding component 630 may be configured to support embedding, in a vector space, a set of multiple vectors corresponding to respective portions of code, where a first vector of the set of multiple vectors indicates one or more historical comments associated with one or more code chunks of the set of multiple code chunks corresponding to a first portion of code. The pull request component 635 may be configured to support receiving a pull request indicating a change to a code chunk of the codebase. The vector identification component 640 may be configured to support determining, from the vector space, a vector of the set of multiple vectors corresponding to a portion of code including the code chunk, where the vector indicates a set of historical comments. The LLM component 645 may be configured to support sending, as an input to an LLM, a prompt including the code chunk and a subset of the set of historical comments based on a relevancy ranking of the set of historical comments. The pull request modification component 650 may be configured to support modifying the pull request to include one or more comments output by the LLM in response to the prompt.

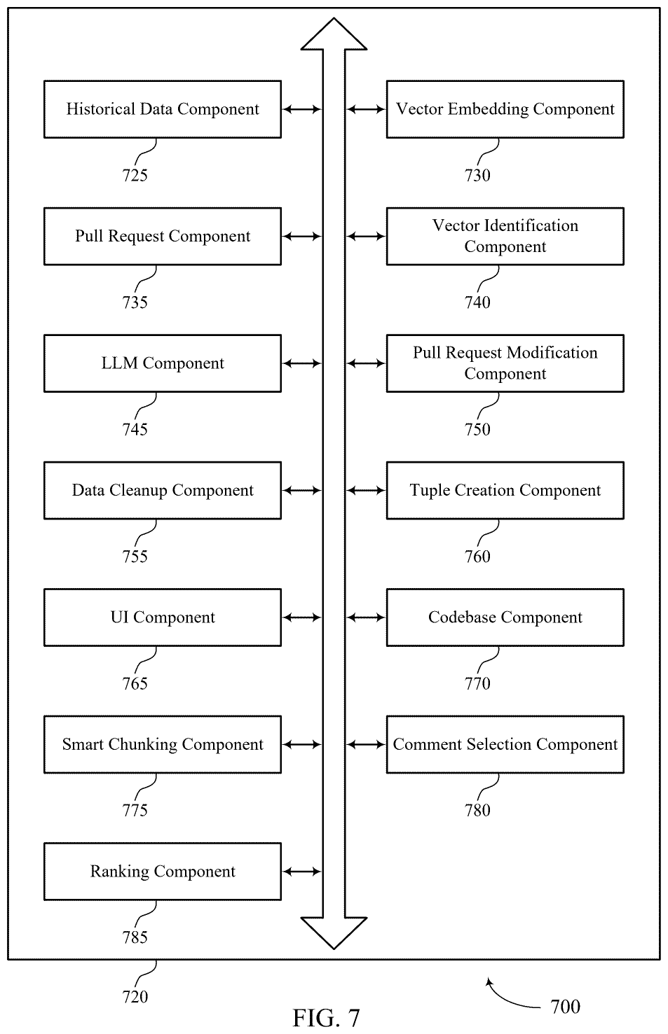

FIG. 7 shows a block diagram 700 of a pull request manager 720 that supports an LLM for modifying pull requests in accordance with aspects of the present disclosure. The pull request manager 720 may be an example of aspects of a processing device or a pull request manager 620, or both, as described herein. The pull request manager 720, or various components thereof, may be an example of means for performing various aspects relating to LLMs for modifying pull requests as described herein. For example, the pull request manager 720 may include a historical data component 725, a vector embedding component 730, a pull request component 735, a vector identification component 740, an LLM component 745, a pull request modification component 750, a data cleanup component 755, a tuple creation component 760, a UI component 765, a codebase component 770, a smart chunking component 775, a comment selection component 780, a ranking component 785, or any combination thereof. Each of these components, or components of subcomponents thereof (e.g., one or more processors, one or more memories), may communicate, directly or indirectly, with one another (e.g., via one or more buses).

The pull request manager 720 may support automatically modifying pull requests in accordance with examples as disclosed herein. The historical data component 725 may be configured to support retrieving, from a codebase, a set of multiple code chunks associated with historical pull requests to the codebase. The vector embedding component 730 may be configured to support embedding, in a vector space, a set of multiple vectors corresponding to respective portions of code, where a first vector of the set of multiple vectors indicates one or more historical comments associated with one or more code chunks of the set of multiple code chunks corresponding to a first portion of code. The pull request component 735 may be configured to support receiving a pull request indicating a change to a code chunk of the codebase. The vector identification component 740 may be configured to support determining, from the vector space, a vector of the set of multiple vectors corresponding to a portion of code including the code chunk, where the vector indicates a set of historical comments. The LLM component 745 may be configured to support sending, as an input to an LLM, a prompt including the code chunk and a subset of the set of historical comments based on a relevancy ranking of the set of historical comments. The pull request modification component 750 may be configured to support modifying the pull request to include one or more comments output by the LLM in response to the prompt.

In some examples, the data cleanup component 755 may be configured to support removing a set of multiple special characters from the retrieved set of multiple code chunks, where the embedding is further based on the removing the set of multiple special characters. In some examples, the data cleanup component 755 may be configured to support serializing a respective code chunk of the set of multiple code chunks into a single line of text, where the embedding is further based on the serializing.

In some examples, the tuple creation component 760 may be configured to support generating a set of multiple tuples corresponding to the set of multiple vectors, where a first tuple corresponding to the first vector indicates a first function and a list including the one or more historical comments and one or more line numbers corresponding to the one or more historical comments, where the embedding is further based on the generated set of multiple tuples.

In some examples, the historical data component 725 may be configured to support retrieving, from the codebase, a set of multiple historical comments associated with the historical pull requests to the codebase. In some examples, the data cleanup component 755 may be configured to support removing, from the set of multiple historical comments, a first subset of comments corresponding to reply comments, a second subset of comments satisfying a comment length threshold, a third subset of comments corresponding to a list of standard comments, or any combination thereof.

In some examples, the UI component 765 may be configured to support sending, for display via a UI of a user device, the modified pull request including the one or more comments. In some other examples, the codebase component 770 may be configured to support sending, to the codebase, the modified pull request.

In some examples, the smart chunking component 775 may be configured to support determining the set of multiple code chunks associated with the historical pull requests based on a smart chunking procedure for the historical pull requests. In some examples, to support determining the set of multiple code chunks, the smart chunking component 775 may be configured to support determining the set of multiple code chunks based on one or more new lines, one or more delimiters, one or more brackets, one or more functions, one or more special characters, or any combination thereof in the historical pull requests.

In some examples, the vector embedding component 730 may be configured to support updating the vector of the set of multiple vectors corresponding to the portion of code including the code chunk based on receiving the pull request.

In some examples, the comment selection component 780 may be configured to support selecting the subset of the set of historical comments further based on a threshold quantity of historical comments for the prompt. In some examples, the threshold quantity of historical comments for the prompt is based on a context window size of the LLM.

In some examples, the ranking component 785 may be configured to support ranking historical comments of the set of historical comments based on timestamps for the historical comments, lengths of the historical comments, line numbers of the historical comments, semantic relationships between the historical comments and corresponding functions, or any combination thereof.

In some examples, to support determining the vector of the set of multiple vectors corresponding to the portion of code including the code chunk, the vector identification component 740 may be configured to support performing a vector search of the vector space based on the pull request, a result of the vector search indicating the vector corresponding to the portion of code. In some examples, to support determining the vector of the set of multiple vectors corresponding to the portion of code including the code chunk, the vector identification component 740 may be configured to support determining a file name match, a function name match, or both between the portion of code and the code chunk associated with the pull request.

In some examples, the respective portions of code include respective functions defined in the codebase. In some examples, the vector of the set of multiple vectors corresponds to a function of the respective functions.

FIG. 8 shows a diagram of a system 800 including a device 805 that supports an LLM for modifying pull requests in accordance with aspects of the present disclosure. The device 805 may be an example of or include components of a device 605 as described herein. The device 805 may include components for bi-directional data communications including components for transmitting and receiving communications, such as a pull request manager 820, an I/O controller, such as an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In some other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the device 805 may include one or more memories 825.

The processor 830 may include an intelligent hardware device (e.g., a general-purpose processor, a digital signal processor (DSP), a CPU, a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in at least one memory 825 to perform various functions (e.g., functions or tasks supporting an LLM for modifying pull requests). The processor 830 may be an example of a single processor or multiple processors. For example, the device 805 may include one or more processors 830.

The pull request manager 820 may support automatically modifying pull requests in accordance with examples as disclosed herein. For example, the pull request manager 820 may be configured to support retrieving, from a codebase, a set of multiple code chunks associated with historical pull requests to the codebase. The pull request manager 820 may be configured to support embedding, in a vector space, a set of multiple vectors corresponding to respective portions of code, where a first vector of the set of multiple vectors indicates one or more historical comments associated with one or more code chunks of the set of multiple code chunks corresponding to a first portion of code. The pull request manager 820 may be configured to support receiving a pull request indicating a change to a code chunk of the codebase. The pull request manager 820 may be configured to support determining, from the vector space, a vector of the set of multiple vectors corresponding to a portion of code including the code chunk, where the vector indicates a set of historical comments. The pull request manager 820 may be configured to support sending, as an input to an LLM, a prompt including the code chunk and a subset of the set of historical comments based on a relevancy ranking of the set of historical comments. The pull request manager 820 may be configured to support modifying the pull request to include one or more comments output by the LLM in response to the prompt.

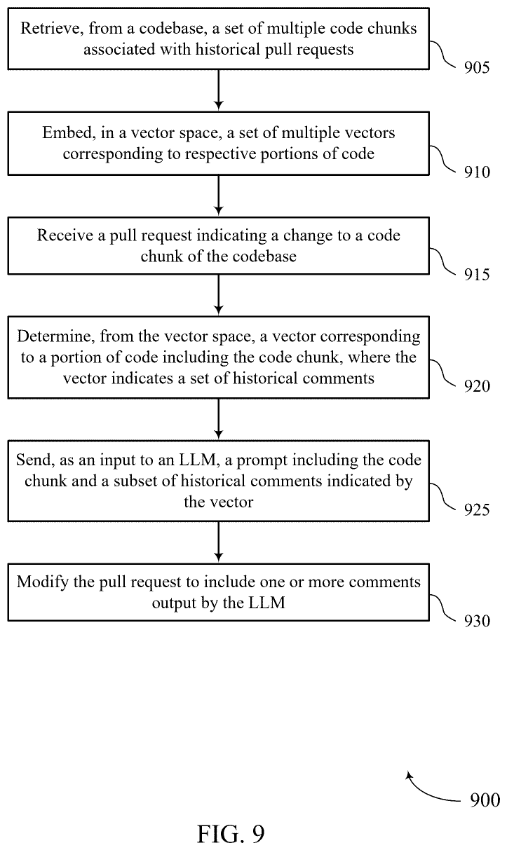

FIG. 9 shows a flowchart illustrating a method 900 that supports an LLM for modifying pull requests in accordance with aspects of the present disclosure. The operations of the method 900 may be implemented by a processing device or its components as described herein. For example, the operations of the method 900 may be performed by a processing device or system, such as an application server, a database server, a cloud-based server or service, a worker server, a server cluster, a virtual machine, a container, a network device, a user device, or any combination of these or other computing devices as described with reference to FIGS. 1 through 8. In some examples, a processing device may execute a set of instructions to control the functional elements of the processing device to perform the described functions. Additionally, or alternatively, the processing device may perform aspects of the described functions using special-purpose hardware.

At 905, the method may include retrieving, from a codebase, a set of multiple code chunks associated with historical pull requests to the codebase. The operations of 905 may be performed in accordance with examples as disclosed herein. In some examples, aspects of the operations of 905 may be performed by a historical data component 725 as described with reference to FIG. 7.

At 910, the method may include embedding, in a vector space, a set of multiple vectors corresponding to respective portions of code. A first vector of the set of multiple vectors may indicate one or more historical comments associated with one or more code chunks of the set of multiple code chunks corresponding to a first portion of code. The operations of 910 may be performed in accordance with examples as disclosed herein. In some examples, aspects of the operations of 910 may be performed by a vector embedding component 730 as described with reference to FIG. 7.

At 915, the method may include receiving a pull request indicating a change to a code chunk of the codebase. The operations of 915 may be performed in accordance with examples as disclosed herein. In some examples, aspects of the operations of 915 may be performed by a pull request component 735 as described with reference to FIG. 7.

At 920, the method may include determining, from the vector space, a vector of the set of multiple vectors corresponding to a portion of code including the code chunk, where the vector indicates a set of historical comments. The operations of 920 may be performed in accordance with examples as disclosed herein. In some examples, aspects of the operations of 920 may be performed by a vector identification component 740 as described with reference to FIG. 7.

At 925, the method may include sending, as an input to an LLM, a prompt including the code chunk and a subset of the set of historical comments based on a relevancy ranking of the set of historical comments. The operations of 925 may be performed in accordance with examples as disclosed herein. In some examples, aspects of the operations of 925 may be performed by an LLM component 745 as described with reference to FIG. 7.

At 930, the method may include modifying the pull request to include one or more comments output by the LLM in response to the prompt. The operations of 930 may be performed in accordance with examples as disclosed herein. In some examples, aspects of the operations of 930 may be performed by a pull request modification component 750 as described with reference to FIG. 7.

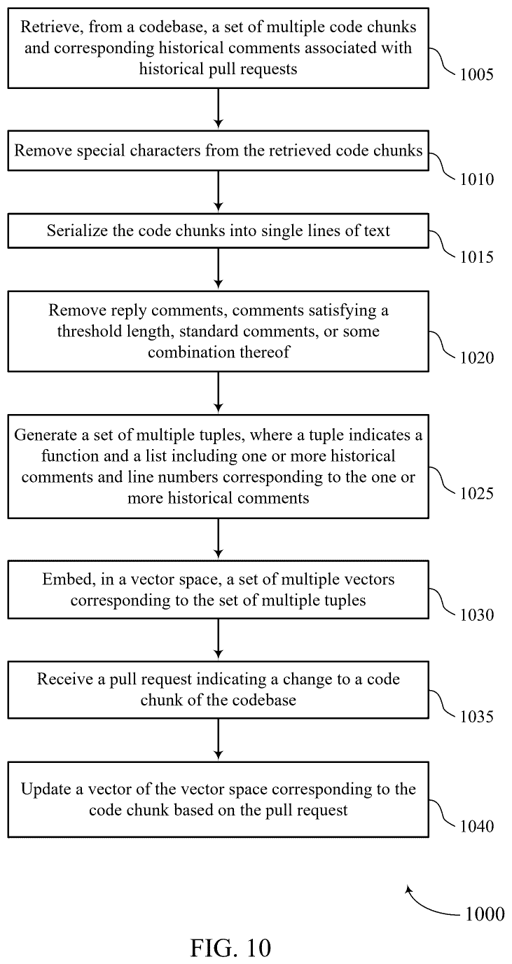

FIG. 10 shows a flowchart illustrating a method 1000 that supports an LLM for modifying pull requests in accordance with aspects of the present disclosure. The operations of the method 1000 may be implemented by a processing device or its components as described herein. For example, the operations of the method 1000 may be performed by a processing device or system, such as an application server, a database server, a cloud-based server or service, a worker server, a server cluster, a virtual machine, a container, a network device, a user device, or any combination of these or other computing devices as described with reference to FIGS. 1 through 8. In some examples, a processing device may execute a set of instructions to control the functional elements of the processing device to perform the described functions. Additionally, or alternatively, the processing device may perform aspects of the described functions using special-purpose hardware.

At 1005, the method may include retrieving, from a codebase, a set of multiple code chunks and a set of multiple historical comments associated with historical pull requests to the codebase. The operations of 1005 may be performed in accordance with examples as disclosed herein. In some examples, aspects of the operations of 1005 may be performed by a historical data component 725 as described with reference to FIG. 7.

At 1010, the method may include removing a set of multiple special characters from the retrieved set of multiple code chunks. The operations of 1010 may be performed in accordance with examples as disclosed herein. In some examples, aspects of the operations of 1010 may be performed by a data cleanup component 755 as described with reference to FIG. 7.

At 1015, the method may include serializing a respective code chunk of the set of multiple code chunks into a single line of text. The operations of 1015 may be performed in accordance with examples as disclosed herein. In some examples, aspects of the operations of 1015 may be performed by a data cleanup component 755 as described with reference to FIG. 7.

At 1020, the method may include removing, from the set of multiple historical comments, a first subset of comments corresponding to reply comments, a second subset of comments satisfying a comment length threshold, a third subset of comments corresponding to a list of standard comments, or any combination thereof. The operations of 1020 may be performed in accordance with examples as disclosed herein. In some examples, aspects of the operations of 1020 may be performed by a data cleanup component 755 as described with reference to FIG. 7.

At 1025, the method may include generating a set of multiple tuples, where a first tuple indicates a first function and a list including the one or more historical comments and one or more line numbers corresponding to the one or more historical comments. The operations of 1025 may be performed in accordance with examples as disclosed herein. In some examples, aspects of the operations of 1025 may be performed by a tuple creation component 760 as described with reference to FIG. 7.

At 1030, the method may include embedding, in a vector space, a set of multiple vectors corresponding to respective tuples of the generated set of multiple tuples. The operations of 1030 may be performed in accordance with examples as disclosed herein. In some examples, aspects of the operations of 1030 may be performed by a vector embedding component 730 as described with reference to FIG. 7.

At 1035, the method may include receiving a pull request indicating a change to a code chunk of the codebase. The operations of 1035 may be performed in accordance with examples as disclosed herein. In some examples, aspects of the operations of 1035 may be performed by a pull request component 735 as described with reference to FIG. 7.

At 1040, the method may include updating a vector of the vector space corresponding to the code chunk based on the pull request. For example, the method may include updating the tuple corresponding to the vector. The operations of 1040 may be performed in accordance with examples as disclosed herein. In some examples, aspects of the operations of 1040 may be performed by a vector embedding component 730 as described with reference to FIG. 7.

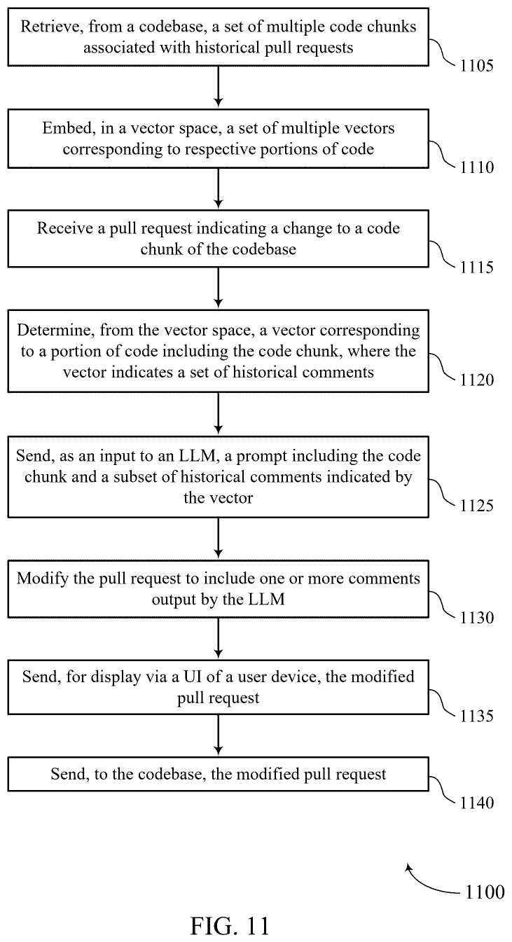

FIG. 11 shows a flowchart illustrating a method 1100 that supports an LLM for modifying pull requests in accordance with aspects of the present disclosure. The operations of the method 1100 may be implemented by a processing device or its components as described herein. For example, the operations of the method 1100 may be performed by a processing device or system, such as an application server, a database server, a cloud-based server or service, a worker server, a server cluster, a virtual machine, a container, a network device, a user device, or any combination of these or other computing devices as described with reference to FIGS. 1 through 8. In some examples, a processing device may execute a set of instructions to control the functional elements of the processing device to perform the described functions. Additionally, or alternatively, the processing device may perform aspects of the described functions using special-purpose hardware.

At 1105, the method may include retrieving, from a codebase, a set of multiple code chunks associated with historical pull requests to the codebase. The operations of 1105 may be performed in accordance with examples as disclosed herein. In some examples, aspects of the operations of 1105 may be performed by a historical data component 725 as described with reference to FIG. 7.

At 1110, the method may include embedding, in a vector space, a set of multiple vectors corresponding to respective portions of code. A first vector of the set of multiple vectors may indicate one or more historical comments associated with one or more code chunks of the set of multiple code chunks corresponding to a first portion of code. The operations of 1110 may be performed in accordance with examples as disclosed herein. In some examples, aspects of the operations of 1110 may be performed by a vector embedding component 730 as described with reference to FIG. 7.

At 1115, the method may include receiving a pull request indicating a change to a code chunk of the codebase. The operations of 1115 may be performed in accordance with examples as disclosed herein. In some examples, aspects of the operations of 1115 may be performed by a pull request component 735 as described with reference to FIG. 7.

At 1120, the method may include determining, from the vector space, a vector of the set of multiple vectors corresponding to a portion of code including the code chunk, where the vector indicates a set of historical comments. The operations of 1120 may be performed in accordance with examples as disclosed herein. In some examples, aspects of the operations of 1120 may be performed by a vector identification component 740 as described with reference to FIG. 7.

At 1125, the method may include sending, as an input to an LLM, a prompt including the code chunk and a subset of the set of historical comments based on a relevancy ranking of the set of historical comments. The operations of 1125 may be performed in accordance with examples as disclosed herein. In some examples, aspects of the operations of 1125 may be performed by an LLM component 745 as described with reference to FIG. 7.

At 1130, the method may include modifying the pull request to include one or more comments output by the LLM in response to the prompt. The operations of 1130 may be performed in accordance with examples as disclosed herein. In some examples, aspects of the operations of 1130 may be performed by a pull request modification component 750 as described with reference to FIG. 7.

In some examples, at 1135, the method may include sending, for display via a UI of a user device, the modified pull request including the one or more comments. The operations of 1135 may be performed in accordance with examples as disclosed herein. In some examples, aspects of the operations of 1135 may be performed by a UI component 765 as described with reference to FIG. 7.

In some examples, at 1140, the method may include sending, to the codebase, the modified pull request. The operations of 1140 may be performed in accordance with examples as disclosed herein. In some examples, aspects of the operations of 1140 may be performed by a codebase component 770 as described with reference to FIG. 7.

A method for automatically modifying pull requests by an apparatus is described. The method may include retrieving, from a codebase, a set of multiple code chunks associated with historical pull requests to the codebase and embedding, in a vector space, a set of multiple vectors corresponding to respective portions of code, where a first vector of the set of multiple vectors indicates one or more historical comments associated with one or more code chunks of the set of multiple code chunks corresponding to a first portion of code. The method may further include receiving a pull request indicating a change to a code chunk of the codebase, determining, from the vector space, a vector of the set of multiple vectors corresponding to a portion of code including the code chunk, where the vector indicates a set of historical comments, sending, as an input to an LLM, a prompt including the code chunk and a subset of the set of historical comments based on a relevancy ranking of the set of historical comments, and modifying the pull request to include one or more comments output by the LLM in response to the prompt.

An apparatus for automatically modifying pull requests is described. The apparatus may include one or more memories storing processor-executable code and one or more processors coupled with the one or more memories. The one or more processors may individually or collectively be operable to execute the code to cause the apparatus to retrieve, from a codebase, a set of multiple code chunks associated with historical pull requests to the codebase and embed, in a vector space, a set of multiple vectors corresponding to respective portions of code, where a first vector of the set of multiple vectors indicates one or more historical comments associated with one or more code chunks of the set of multiple code chunks corresponding to a first portion of code. The one or more processors may individually or collectively be further operable to execute the code to cause the apparatus to receive a pull request indicating a change to a code chunk of the codebase, determine, from the vector space, a vector of the set of multiple vectors corresponding to a portion of code including the code chunk, where the vector indicates a set of historical comments, send, as an input to an LLM, a prompt including the code chunk and a subset of the set of historical comments based on a relevancy ranking of the set of historical comments, and modify the pull request to include one or more comments output by the LLM in response to the prompt.

Another apparatus for automatically modifying pull requests is described. The apparatus may include means for retrieving, from a codebase, a set of multiple code chunks associated with historical pull requests to the codebase and means for embedding, in a vector space, a set of multiple vectors corresponding to respective portions of code, where a first vector of the set of multiple vectors indicates one or more historical comments associated with one or more code chunks of the set of multiple code chunks corresponding to a first portion of code. The apparatus may further include means for receiving a pull request indicating a change to a code chunk of the codebase, means for determining, from the vector space, a vector of the set of multiple vectors corresponding to a portion of code including the code chunk, where the vector indicates a set of historical comments, means for sending, as an input to an LLM, a prompt including the code chunk and a subset of the set of historical comments based on a relevancy ranking of the set of historical comments, and means for modifying the pull request to include one or more comments output by the LLM in response to the prompt.

A non-transitory computer-readable medium storing code for automatically modifying pull requests is described. The code may include instructions executable by one or more processors to retrieve, from a codebase, a set of multiple code chunks associated with historical pull requests to the codebase and embed, in a vector space, a set of multiple vectors corresponding to respective portions of code, where a first vector of the set of multiple vectors indicates one or more historical comments associated with one or more code chunks of the set of multiple code chunks corresponding to a first portion of code. The code may further include instructions executable by the one or more processors to receive a pull request indicating a change to a code chunk of the codebase, determine, from the vector space, a vector of the set of multiple vectors corresponding to a portion of code including the code chunk, where the vector indicates a set of historical comments, send, as an input to an LLM, a prompt including the code chunk and a subset of the set of historical comments based on a relevancy ranking of the set of historical comments, and modify the pull request to include one or more comments output by the LLM in response to the prompt.

Some examples of the method, apparatuses, and non-transitory computer-readable medium described herein may further include operations, features, means, or instructions for removing a set of multiple special characters from the retrieved set of multiple code chunks, where the embedding may be further based on the removing the set of multiple special characters.

Some examples of the method, apparatuses, and non-transitory computer-readable medium described herein may further include operations, features, means, or instructions for serializing a respective code chunk of the set of multiple code chunks into a single line of text, where the embedding may be further based on the serializing.

Some examples of the method, apparatuses, and non-transitory computer-readable medium described herein may further include operations, features, means, or instructions for generating a set of multiple tuples corresponding to the set of multiple vectors, where a first tuple corresponding to the first vector indicates a first function and a list including the one or more historical comments and one or more line numbers corresponding to the one or more historical comments, where the embedding may be further based on the generated set of multiple tuples.

Some examples of the method, apparatuses, and non-transitory computer-readable medium described herein may further include operations, features, means, or instructions for retrieving, from the codebase, a set of multiple historical comments associated with the historical pull requests to the codebase and removing, from the set of multiple historical comments, a first subset of comments corresponding to reply comments, a second subset of comments satisfying a comment length threshold, a third subset of comments corresponding to a list of standard comments, or any combination thereof.

Some examples of the method, apparatuses, and non-transitory computer-readable medium described herein may further include operations, features, means, or instructions for sending, for display via a UI of a user device, the modified pull request including the one or more comments.

Some examples of the method, apparatuses, and non-transitory computer-readable medium described herein may further include operations, features, means, or instructions for sending, to the codebase, the modified pull request.

Some examples of the method, apparatuses, and non-transitory computer-readable medium described herein may further include operations, features, means, or instructions for determining the set of multiple code chunks associated with the historical pull requests based on a smart chunking procedure for the historical pull requests. In some examples of the method, apparatuses, and non-transitory computer-readable medium described herein, determining the set of multiple code chunks may include operations, features, means, or instructions for determining the set of multiple code chunks based on one or more new lines, one or more delimiters, one or more brackets, one or more functions, one or more special characters, or any combination thereof in the historical pull requests.

Some examples of the method, apparatuses, and non-transitory computer-readable medium described herein may further include operations, features, means, or instructions for updating the vector of the set of multiple vectors corresponding to the portion of code including the code chunk based on receiving the pull request.

Some examples of the method, apparatuses, and non-transitory computer-readable medium described herein may further include operations, features, means, or instructions for selecting the subset of the set of historical comments further based on a threshold quantity of historical comments for the prompt. In some examples of the method, apparatuses, and non-transitory computer-readable medium described herein, the threshold quantity of historical comments for the prompt may be based on a context window size of the LLM.

Some examples of the method, apparatuses, and non-transitory computer-readable medium described herein may further include operations, features, means, or instructions for ranking historical comments of the set of historical comments based on timestamps for the historical comments, lengths of the historical comments, line numbers of the historical comments, semantic relationships between the historical comments and corresponding functions, or any combination thereof.

In some examples of the method, apparatuses, and non-transitory computer-readable medium described herein, determining the vector of the set of multiple vectors corresponding to the portion of code including the code chunk may include operations, features, means, or instructions for performing a vector search of the vector space based on the pull request, a result of the vector search indicating the vector corresponding to the portion of code, and determining a file name match, a function name match, or both between the portion of code and the code chunk associated with the pull request.

In some examples of the method, apparatuses, and non-transitory computer-readable medium described herein, the respective portions of code include respective functions defined in the codebase, and the vector of the set of multiple vectors corresponds to a function of the respective functions.

The following provides an overview of aspects of the present disclosure:

Aspect 1: A method for automatically modifying pull requests, comprising: retrieving, from a codebase, a plurality of code chunks associated with historical pull requests to the codebase; embedding, in a vector space, a plurality of vectors corresponding to respective portions of code, wherein a first vector of the plurality of vectors indicates one or more historical comments associated with one or more code chunks of the plurality of code chunks corresponding to a first portion of code; receiving a pull request indicating a change to a code chunk of the codebase; determining, from the vector space, a vector of the plurality of vectors corresponding to a portion of code comprising the code chunk, wherein the vector indicates a set of historical comments; sending, as an input to an LLM, a prompt comprising the code chunk and a subset of the set of historical comments based at least in part on a relevancy ranking of the set of historical comments; and modifying the pull request to comprise one or more comments output by the LLM in response to the prompt.

Aspect 2: The method of aspect 1, further comprising: removing a plurality of special characters from the retrieved plurality of code chunks, wherein the embedding is further based at least in part on the removing the plurality of special characters.

Aspect 3: The method of either of aspects 1 or 2, further comprising: serializing a respective code chunk of the plurality of code chunks into a single line of text, wherein the embedding is further based at least in part on the serializing.

Aspect 4: The method of any of aspects 1 through 3, further comprising: generating a plurality of tuples corresponding to the plurality of vectors, wherein a first tuple corresponding to the first vector indicates a first function and a list comprising the one or more historical comments and one or more line numbers corresponding to the one or more historical comments, wherein the embedding is further based at least in part on the generated plurality of tuples.

Aspect 5: The method of any of aspects 1 through 4, further comprising: retrieving, from the codebase, a plurality of historical comments associated with the historical pull requests to the codebase; and removing, from the plurality of historical comments, a first subset of comments corresponding to reply comments, a second subset of comments satisfying a comment length threshold, a third subset of comments corresponding to a list of standard comments, or any combination thereof.

Aspect 6: The method of any of aspects 1 through 5, further comprising: sending, for display via a UI of a user device, the modified pull request comprising the one or more comments.

Aspect 7: The method of any of aspects 1 through 5, further comprising: sending, to the codebase, the modified pull request.

Aspect 8: The method of any of aspects 1 through 7, further comprising: determining the plurality of code chunks associated with the historical pull requests based at least in part on a smart chunking procedure for the historical pull requests.

Aspect 9: The method of aspect 8, wherein determining the plurality of code chunks comprises: determining the plurality of code chunks based at least in part on one or more new lines, one or more delimiters, one or more brackets, one or more functions, one or more special characters, or any combination thereof in the historical pull requests.

Aspect 10: The method of any of aspects 1 through 9, further comprising: updating the vector of the plurality of vectors corresponding to the portion of code comprising the code chunk based at least in part on receiving the pull request.

Aspect 11: The method of any of aspects 1 through 10, further comprising: selecting the subset of the set of historical comments further based at least in part on a threshold quantity of historical comments for the prompt.

Aspect 12: The method of aspect 11, wherein the threshold quantity of historical comments for the prompt is based at least in part on a context window size of the LLM.

Aspect 13: The method of any of aspects 1 through 12, further comprising: ranking historical comments of the set of historical comments based at least in part on timestamps for the historical comments, lengths of the historical comments, line numbers of the historical comments, semantic relationships between the historical comments and corresponding functions, or any combination thereof.

Aspect 14: The method of any of aspects 1 through 13, wherein determining the vector of the plurality of vectors corresponding to the portion of code comprising the code chunk further comprises: performing a vector search of the vector space based at least in part on the pull request, a result of the vector search indicating the vector corresponding to the portion of code; and determining a file name match, a function name match, or both between the portion of code and the code chunk associated with the pull request.

Aspect 15: The method of any of aspects 1 through 14, wherein the respective portions of code comprise respective functions defined in the codebase; and the vector of the plurality of vectors corresponds to a function of the respective functions.

Aspect 16: An apparatus for automatically modifying pull requests, comprising: one or more memories storing processor-executable code; and one or more processors coupled with the one or more memories and individually or collectively operable to execute the code to cause the apparatus to perform a method of any of aspects 1 through 15.

Aspect 17: An apparatus for automatically modifying pull requests, comprising at least one means for performing a method of any of aspects 1 through 15.

Aspect 18: A non-transitory computer-readable medium storing code for automatically modifying pull requests, the code comprising instructions executable by one or more processors to perform a method of any of aspects 1 through 15.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for automatically modifying pull requests, comprising:
retrieving, from a codebase, a plurality of code chunks associated with historical pull requests to the codebase;
embedding, in a vector space, a plurality of vectors corresponding to respective portions of code, wherein a first vector of the plurality of vectors indicates one or more historical comments associated with one or more code chunks of the plurality of code chunks corresponding to a first portion of code;
receiving a pull request indicating a change to a code chunk of the codebase;
determining, from the vector space, a vector of the plurality of vectors corresponding to a portion of code comprising the code chunk, wherein the vector indicates a set of historical comments;
sending, as an input to a large language model (LLM), a prompt comprising the code chunk and a subset of the set of historical comments based at least in part on a relevancy ranking of the set of historical comments; and
modifying the pull request to comprise one or more comments output by the LLM in response to the prompt.

2. The method of claim 1, further comprising:
removing a plurality of special characters from the retrieved plurality of code chunks, wherein the embedding is further based at least in part on the removing the plurality of special characters.

3. The method of claim 1, further comprising:
serializing a respective code chunk of the plurality of code chunks into a single line of text, wherein the embedding is further based at least in part on the serializing.

4. The method of claim 1, further comprising:
generating a plurality of tuples corresponding to the plurality of vectors, wherein a first tuple corresponding to the first vector indicates a first function and a list comprising the one or more historical comments and one or more line numbers corresponding to the one or more historical comments, wherein the embedding is further based at least in part on the generated plurality of tuples.

5. The method of claim 1, further comprising:
retrieving, from the codebase, a plurality of historical comments associated with the historical pull requests to the codebase; and
removing, from the plurality of historical comments, a first subset of comments corresponding to reply comments, a second subset of comments satisfying a comment length threshold, a third subset of comments corresponding to a list of standard comments, or any combination thereof.

6. The method of claim 1, further comprising:
sending, for display via a user interface of a user device, the modified pull request comprising the one or more comments.

7. The method of claim 1, further comprising:
sending, to the codebase, the modified pull request.

8. The method of claim 1, further comprising:
determining the plurality of code chunks associated with the historical pull requests based at least in part on a smart chunking procedure for the historical pull requests.

9. The method of claim 8, wherein determining the plurality of code chunks comprises:
determining the plurality of code chunks based at least in part on one or more new lines, one or more delimiters, one or more brackets, one or more functions, one or more special characters, or any combination thereof in the historical pull requests.

10. The method of claim 1, further comprising:
updating the vector of the plurality of vectors corresponding to the portion of code comprising the code chunk based at least in part on receiving the pull request.

11. The method of claim 1, further comprising:
selecting the subset of the set of historical comments further based at least in part on a threshold quantity of historical comments for the prompt.

12. The method of claim 11, wherein the threshold quantity of historical comments for the prompt is based at least in part on a context window size of the LLM.

13. The method of claim 1, further comprising:
ranking historical comments of the set of historical comments based at least in part on timestamps for the historical comments, lengths of the historical comments, line numbers of the historical comments, semantic relationships between the historical comments and corresponding functions, or any combination thereof.

14. The method of claim 1, wherein determining the vector of the plurality of vectors corresponding to the portion of code comprising the code chunk further comprises:
performing a vector search of the vector space based at least in part on the pull request, a result of the vector search indicating the vector corresponding to the portion of code; and
determining a file name match, a function name match, or both between the portion of code and the code chunk associated with the pull request.

15. The method of claim 1, wherein:
the respective portions of code comprise respective functions defined in the codebase; and
the vector of the plurality of vectors corresponds to a function of the respective functions.

16. An apparatus for automatically modifying pull requests, comprising:
one or more memories storing processor-executable code; and
one or more processors coupled with the one or more memories and individually or collectively operable to execute the processor-executable code to cause the apparatus to:
retrieve, from a codebase, a plurality of code chunks associated with historical pull requests to the codebase;
embed, in a vector space, a plurality of vectors corresponding to respective portions of code, wherein a first vector of the plurality of vectors indicates one or more historical comments associated with one or more code chunks of the plurality of code chunks corresponding to a first portion of code;
receive a pull request indicating a change to a code chunk of the codebase;
determine, from the vector space, a vector of the plurality of vectors corresponding to a portion of code comprising the code chunk, wherein the vector indicates a set of historical comments;
send, as an input to a large language model (LLM), a prompt comprising the code chunk and a subset of the set of historical comments based at least in part on a relevancy ranking of the set of historical comments; and
modify the pull request to comprise one or more comments output by the LLM in response to the prompt.

17. The apparatus of claim 16, wherein the one or more processors are individually or collectively further operable to execute the processor-executable code to cause the apparatus to:
remove a plurality of special characters from the retrieved plurality of code chunks, wherein the embedding is further based at least in part on the removing the plurality of special characters.

18. The apparatus of claim 16, wherein the one or more processors are individually or collectively further operable to execute the processor-executable code to cause the apparatus to:
serialize a respective code chunk of the plurality of code chunks into a single line of text, wherein the embedding is further based at least in part on the serializing.

19. The apparatus of claim 16, wherein the one or more processors are individually or collectively further operable to execute the processor-executable code to cause the apparatus to:
generate a plurality of tuples corresponding to the plurality of vectors, wherein a first tuple corresponding to the first vector indicates a first function and a list comprising the one or more historical comments and one or more line numbers corresponding to the one or more historical comments, wherein the embedding is further based at least in part on the generated plurality of tuples.

20. A non-transitory computer-readable medium storing code for automatically modifying pull requests, the code comprising instructions executable by one or more processors to:
retrieve, from a codebase, a plurality of code chunks associated with historical pull requests to the codebase;
embed, in a vector space, a plurality of vectors corresponding to respective portions of code, wherein a first vector of the plurality of vectors indicates one or more historical comments associated with one or more code chunks of the plurality of code chunks corresponding to a first portion of code;
receive a pull request indicating a change to a code chunk of the codebase;
determine, from the vector space, a vector of the plurality of vectors corresponding to a portion of code comprising the code chunk, wherein the vector indicates a set of historical comments;
send, as an input to a large language model (LLM), a prompt comprising the code chunk and a subset of the set of historical comments based at least in part on a relevancy ranking of the set of historical comments; and
modify the pull request to comprise one or more comments output by the LLM in response to the prompt.
